(19) United States
(12) Patent Application Publication
(10) Pub. No.: US 2005/0131137 A1
(43) Pub. Date: Jun. 16, 2005

(54) Polymer dispersions in polyesterpolyols

(76) Inventors: Hartmut Nefzger, Pulheim (DE); Erika Bauer, Juchen (DE); Erhard Michels, Koln (DE)

Correspondence Address: BAYER MATERIAL SCIENCE LLC, 100 BAYER ROAD, PITTSBURGH, PA, 15205, US

(21) Appl. No.: 11/006,103

(22) Filed: Dec. 7, 2004

(30) Foreign Application Priority Data
Dec. 11, 2003 (DE) 10357895.1

(51) Int. Cl. C08K 3/20

(52) U.S. Cl. 524/591

(57) ABSTRACT

The present invention relates to polymer dispersions in polyester polyols, to a process for their preparation of these polymer dispersions and to their use for the preparation of polyurethanes, especially microcellular polyurethanes.

### BACKGROUND OF THE INVENTION

The present invention relates to polymer dispersions in polyester polyols, to a process for their preparation and to their use for the preparation of polyurethanes, and particularly for microcellular polyurethanes.

Dispersions of solid, high-molecular weight polymers in polyols (i.e. polymer polyols) are frequently used for the production of flexible polyurethane foams. One advantage here is, for example, that the open-cell character of these foams is increased and the mechanical properties are improved as a consequence of the increased hardness. Tear strength, tensile stress and compression set may be mentioned in this connection. These means make it possible to reduce the density of the foam while retaining the properties otherwise achievable only with a higher density foam. This affords a significant saving of materials and hence a reduction of the costs.

Dispersions of polymers in polyols are known in the literature. In addition to dispersions obtainable by reacting monomers containing olefin groups in polyols, the literature also describes other types of dispersions such as, for example, those prepared from diamines and polyisocyanates. The literature also makes it clear that the base polyols used are generally polyether polyols with molecular weights of 1,000 to 10,000 g/mol or, more rarely, polyester polyols. One reason for occasionally using polyester polyols may lie in the comparatively high viscosity of polyester polyols themselves, and especially in the resulting dispersions based on polyester polyols, particularly in comparison with corresponding systems based on polyether polyols. Nevertheless, dispersions based on polyester polyols are of technical interest, especially because polyurethane systems prepared therefrom have in many different respects better mechanical properties than the corresponding polyurethanes based on polyether polyols.

For aqueous systems for the production of heat-curable stoving lacquers, DE-OS 44 27 227 describes the use of aqueous dispersions of polyester polyols, filled with polymers of olefinic monomers, as one of the system components.

If styrene is used as a vinylic monomer in such systems, then because of its lower reactivity compared with acrylonitrile and the slower chain transfer rate to many molecular species, otherwise analogous dispersions are less stable. Accordingly, the use of styrene as a vinylic monomer polymerizable by free-radical polymerization for the preparation of dispersions based on polyester polyols requires the incorporation of grafting sites into or at the end of the polyester polyol molecules. This applies particularly if styrene is used exclusively as the vinylic monomer. Such grafting sites must assure the chain transfer of the polymer molecules growing by a free-radical process, to form covalent bonds and, if possible, to give the growing free-radical chain.

Some examples of such modifications are listed in EP-A 250 351. Thus, for example, the incorporation of maleic anhydride into the polyester polyol chain can fulfill this function. EP-A 0 250 351 discloses a process in which at least one ethylenically unsaturated monomer is polymerized in a polyester polyol with a molecular weight of 1,000 to 5,000 g/mol. In this particular case, in addition to the conventional structural units, i.e. the polycarboxylic acid and the polyalcohol, the polyester polyol also contains olefinic constituents, especially the structural unit maleic anhydride.

However, a disadvantage of the incorporation of such unsaturated polycarboxylic acids or anhydrides that reduce the free mobility of the segments of the polyester chain is the associated increase in viscosity of the polyester polyols or polyester polyol mixtures used. Similarly, the increased concentration of polar ester carbonyl groups due to the incorporation of maleic acid into the polyester chain also has a viscosity-increasing effect. The increased viscosity further restricts the suitability of the polyester polyols, which already are of higher viscosity per se.

In addition to these disadvantages, it has been found, in industrial practice, that in very many cases polyester polyols modified with unsaturated structural units give coarse dispersions that usually contain particles visible to the naked eye and are often difficult to filter.

The object of the present invention is therefore to provide an improved process for the preparation of polymer polyols based on polyester polyols.

It has now been found that the concomitant use, as a constituent of the polyester polyol, of a small amount of an OH prepolymer, obtainable by reacting tetrahydrofuran oligomers with a substoichiometric proportion of polyisocyanate, leads to improved polyester polyol dispersions.

### SUMMARY OF THE PRESENT INVENTION

The present invention therefore relates to polymer dispersions. This polymer dispersion comprises at least one OH-terminated prepolymer which comprises the reaction product of (1) tetrahydrofuran oligomers, with (2) a substoichiometric proportion of a polyisocyanate component.

The invention also provides a process for the preparation of the polymer dispersions. In accordance with the present invention, polymer dispersions are prepared by (1) free-radically polymerizing (a) one or more olefinically unsaturated monomers in the presence of (b) at least one polyester polyols without olefinically unsaturated groups, and (c) an OH-terminated prepolymer prepared by reacting (1) tetrahydrofuran oligomers, with (2) a substoichiometric proportion of a polyisocyanate component.

The invention also relates to polymer dispersions comprising the free-radical polymerization product of (a) one or more olefinically unsaturated monomers in the presence of (b) at least one polyester polyol component and (c) an OH-terminated prepolymer that comprises the reaction product of (1) tetrahydrofuran oligomers, with (2) a substoichiometric proportion of a polyisocyanate component.

### DETAILED DESCRIPTION OF THE INVENTION

Suitable base polyester polyols for the present invention are those prepared from components that do not contain olefinic constituents. The base polyester polyols are the polycondensation products of diols and dicarboxylic acids or their anhydrides, or low-molecular esters or half-esters, preferably those with monofunctional alcohols such as methanol, ethanol, 1-propanol, 2-propanol, 1-butanol and 2-butanol. These polycondensation products containing hydroxyl end groups.

Examples of suitable diols include compounds such as ethylene glycol, 1,2-propanediol, 1,3-propanediol, 2-methyl-1,3-propanediol, 1,4-butanediol, 1,5-pentanediol, 3-methyl-1,5-pentanediol, 1,6-hexanediol, 1,8-octanediol, 1,10-decanediol, neopentyl glycol, diethylene glycol, triethylene glycol, tetraethylene glycol, etc. Polyether polyols with number-average molecular weights of 250 to 4,500 g/mol are also suitable, and particularly those which predominantly contain units derived from 1,2-propylene oxide. Accordingly, ether oligomers of butanediol, such as dibutylene glycol and tributylene glycol, or corresponding diols obtainable by the ring-opening polymerization of tetrahydrofuran, having number-average molecular weights of 240 to 3,000 g/mol, can also be used as diols. Corresponding compounds of 1,6-hexanediol, dihexylene glycol and trihexylene glycol, or oligomer mixtures obtainable by the azeotropic etherification of 1,6-hexanediol, are also suitable.

It is also possible to incorporate up to 5 wt. % of higher-functional polyols. These higher functional polyols include, for example, 1,1,1-trimethylolpropane, glycerol or pentaerythritol, and polypropylene oxide and polyethylene oxide polyols based on the latter as starter molecules, and which have number-average molecular weights of 250 to 4,500 g/mol.

Non-olefinic dicarboxylic acids which are suitable include aliphatic and aromatic compounds, either used individually or in a mixture. Examples which may be mentioned include succinic acid, glutaric acid, adipic acid, pimelic acid, suberic acid, sebacic acid, phthalic acid, isophthalic acid and terephthalic acid. It is also possible to use the corresponding anhydrides, and their esters or half-esters with low-molecular, and preferably monofunctional alcohols.

Analogously, esters of cyclic hydroxycarboxylic acids can also be used. Preferred are those which can be prepared from ε-caprolactone.

Accordingly, it is also possible to use or incorporate polyesters of carbonic acid, i.e. polycarbonate polyols. These can be prepared by the transesterification of dimethyl carbonate or diphenyl carbonate with diols and triols, and by the transesterification with oligoesterdiols and oligoetherdiols containing hydroxyl end groups, with number-average molecular weights of 200 to 1,000 g/mol.

The polyester polyols suitable for use in accordance with the present invention have a mean hydroxyl functionality of 1.8 to 3, preferably of 1.85 to 2.7 and particularly preferably of 1.9 to 2.5, and a number-average molecular weight of 1,000 to 5,000, preferably of 1,300 to 4,800 and particularly preferably of 1,600 to 4,500 g/mol.

If the base polyester polyol component comprises several polyester polyols, the molecular weight limits as set forth in the above paragraph refer to the mixture of polyester polyols. In this case, it is of course possible for the number-average molecular weight of at least one of the individual components to fall outside the indicated limits, e.g. in the range from 450 to 1,600 g/mol.

The OH-terminated prepolymers suitable for the present invention can be obtained by reacting (1) oligomers of tetrahydrofuran (‘THF oligomers’), with (2) a substoichiometric proportion of a polyisocyanate component. The THF oligomers, which are known per se, are conventionally prepared by the ring-opening polymerization of tetrahydrofuran under acid catalysis, and these normally contain two hydroxyl end groups per molecule and have number-average molecular weights of 200 to 3,000, preferably of 240 to 2,000 and particularly preferably of 250 to 1,000 g/mol. The molar starting ratios of isocyanate groups to hydroxyl groups in this case are 0:1 to 0.9:1, preferably 0:1 to 0.7:1 and particularly preferably 0.3:1 to 0.6:1.

Suitable compounds to be used as the polyisocyanate component for the preparation of the OH-terminated prepolymers include, for example, aliphatic and aromatic polyisocyanates such as, for example, hexamethylene diisocyanate, isophorone diisocyanate, 2,4- and 2,6-toluene diisocyanate or mixtures thereof, polyisocyanates of the diphenylmethane diisocyanate series, including their higher-nuclear representatives (i.e. PMDI or polymeric MDI), or mixtures thereof, and naphthalene 1,5-diisocyanate.

It is particularly preferred to use polyisocyanates of the diphenylmethane series including those with proportions of so-called dinuclear species (2,2′-, 2,4′- and 4,4′-isomers) of less than 50 wt. %, i.e. those in which the monomeric MDI content is less than 50 wt. %, or those with a mean functionality of at least 2.2.

The OH-terminated prepolymers are used in the present invention in amounts such that their proportion, based on the total reaction batch, including the vinylic (i.e. olefinically unsaturated) monomers polymerizable by free-radical polymerization and any solvents, is from about 0.05 to about 15 wt. %.

Some examples of suitable vinylic (i.e. olefinically unsaturated) monomers that are polymerizable by free-radical polymerization are styrene, alpha-methylstyrene, ethylstyrene, vinyltoluene, divinylbenzene, isopropylstyrene, chlorostyrene, butadiene, isoprene, pentadiene, acrylic acid, methacrylic acid, methyl methacrylate, vinyl acetate, acrylonitrile, methyl vinyl ketone or combinations of these compounds. It is preferable to use styrene, alpha-methylstyrene, acrylonitrile, methacrylonitrile and alkyl methacrylates having C₁-C₃₀ alkyl radicals (e.g. methyl, ethyl, butyl, hexyl, dodecyl, etc.). It is particularly preferable to use styrene and acrylonitrile, with the styrene being used in a proportion preferably of more than 75 wt. % and particularly preferably of more than 90 wt. %.

In accordance with the present invention, the proportion of these vinylic monomers polymerizable by free-radical polymerization present in the final polymer dispersion i.e. the filler (solids) content of the finished dispersion, is from about 2 to about 55 wt. %, preferably from about 4 to about 40 wt. % and particularly preferably from about 5 to about 33 wt. %. The filler content can be adjusted by post-dilution of a polymer dispersion with a second base polyester polyol.

In a preferred embodiment, the base polyester polyol component used consists of two different polyester polyols which differ at least with respect to their number-average molecular weights. In this preferred embodiment, the polyester polyol having the smaller molecular weight is mixed in only when the free-radical polymerization of the vinylic monomer in the mixture of polyester polyol of higher molecular weight and the OH-terminated prepolymer has ended.

The free-radical polymerization is initiated using any free-radical initiators which are known per se. Examples of suitable initiators from the group of the azo initiators include alpha, alpha′-azo-2-methylbutyronitrile, alpha, alpha′-azo-2-heptonitrile, 1,1′-azo-1-cyclohexanecarbonitrile, dimethyl alpha, alpha′-azoisobutyrate, 4,4′-azo-4-cyanopentanoic acid, azobis(2-methylbutyronitrile) and azobisisobutyronitrile. The following may be mentioned as examples of other suitable initiators from the group of the peroxides, persulfates, perborates and percarbonates: dibenzoyl peroxide, acetyl peroxide, benzoyl hydroperoxide; t-butyl hydroperoxide, di-t-butyl peroxide, 2-ethylhexanoic acid tert-butyl perester, diisopropyl peroxydicarbonate, etc.

The free-radical polymerization is typically carried out in the presence of a solvent, but can also be effected without a solvent. Examples of suitable solvents for the present invention include solvents such as benzene, toluene, xylene, acetonitrile, hexane, heptane, dioxane, ethyl acetate, N,N-dimethylformamide, N,N-dimethylacetamide, etc. Benzene, xylene and toluene are preferred.

The invention also relates to the polymer dispersions obtained by the processes according to the invention. The products (i.e. polymer dispersion) obtained are white dispersions containing a high-molecular weight polymer or copolymer, a conventional polyester polyol that is solid or, preferably, liquid at room temperature, and an OH-terminated prepolymer which is necessary for phase stabilization. By way of example, for a filler (i.e. solids) content of 25 wt. % of polystyrene and an OH number of 50 to 60, these polymer dispersions can have viscosities of 15,000 to 35,000 mPas at 25° C., and of 3,000 to 8,000 mPas at 50° C. The viscosity of the polymer dispersion is proportional to the viscosity of the base polyester polyol used, and inversely proportional to the OH number of the base polyester polyol.

The polymer polyols prepared according to the invention are suitable for the preparation of polyurethanes or polyurethane materials, and particularly for the preparation of microcellular polyurethane elastomers such as those used, for example, in the production of shoe soles. The invention also relates to polyurethanes (preferably microcellular polyurethanes which can be used to produce shoe soles) which are the reaction product of the polymer dispersions according to the invention, with a polyisocyanate or a polyisocyanate prepolymer. The invention also relates to shoe soles comprising the reaction product of the polymer dispersions with polyisocyanates or polyisocyanate prepolymers.

The polymer dispersions according to the invention result in polyurethanes which have a greater hardness than polyurethanes' prepared without a polymer dispersion, at the same density. If not only the density but also the hardness of the resultant polyurethane is to be kept constant, the process can be carried out with a markedly reduced amount of polyisocyanate by using the polymer dispersions according to the invention.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

A.) Base polyesterpolyols
B.) OH-terminated prepolymers and modified polyester polyols
C.) Polymer dispersions
   A.) Base Polyester Polyols
   A.1. Polyetherester Polyol

This polyetherester polyol was prepared by slowly heating adipic acid, ethylene glycol, butanediol, diethylene glycol and a difunctional polyetherpolyol with a propylene oxide content of approx. 70% and an ethylene oxide content of approx. 30% and an OH number of 28 mg KOH/g, in a weight ratio of 36.53:5.19:9.53:8.67:28.97, to 200° C., with water being eliminated. When the formation of water had ended, the mixture was cooled to 120° C. and catalyzed with 180 mg of tin dichloride. The reaction mixture was heated slowly to 200° C. over 4 hrs. under a water jet vacuum, with additional water being eliminated. The mixture was left to stand for a further 24 hrs. under these reaction conditions and the hydroxyl number of polyetherester polyol A. 1. was then determined to be 39.1 mg KOH/g and the viscosity was 1070 mPas (75° C.).

A.2. Base Polyesterpolyol of High Molecular Weight

This polyester polyol was prepared by slowly heating 2779 g (26.22 mol) of diethylene glycol, 813 g (13.12 mol) of ethylene glycol and 5452 g (37.12 mol) of adipic acid to 200° C., with water being eliminated. When the formation of water had ended, the mixture was cooled to 120° C. and catalyzed with 180 mg of tin dichloride. The reaction mixture was heated slowly to 200° C. over 4 hrs. under a water jet vacuum, with additional water being eliminated. The mixture was left to stand for a further 24 hrs. under these reaction conditions and the hydroxyl number of polyester polyol A.2. was then determined to be 27.8 mg KOH/g and the acid number was 0.8 mg KOH/g.

A.3. Base Polyesterpolyol of Low Molecular Weight

This polyester polyol was prepared by slowly heating 2628 g (24.79 mol) of diethylene glycol, 1538 g (24.79 mol) of ethylene glycol and 5970 g (40.89 mol) of adipic acid to 200° C., with water being eliminated. When the formation of water had ended, the mixture was cooled to 120° C. and catalyzed with 180 mg of tin dichloride. The reaction mixture was heated slowly to 200° C. over 4 hrs. under a water jet vacuum, with additional water being eliminated. The mixture was left to stand for a further 24 hrs. under these reaction conditions and the hydroxyl number of polyester polyol A.3. was then determined to be 98.1 mg KOH/g and the acid number was 0.3 mg KOH/g. Polyester polyol A.3. has a viscosity of 210 mPas (at 75° C.).

A.4. Base Polyester Polyol

A commercially available polyadipate polyester polyol prepared from adipic acid and a mixture of ethylene glycol and butylene glycol, with an OH number of approx. 56 mg KOH/g and a viscosity of approx. 620 mPas (at 75° C.).

A.5. Base Polyester Polyol of Low Molecular Weight

This polyester polyol was prepared by slowly heating 1208 g (11.4 mol) of diethylene glycol, 1208 g (19.48 mol) of ethylene glycol, 1208 g (13.42 mol) of butanediol and 5840 g (40 mol) of adipic acid to 200° C., with water being eliminated. When the formation of water had ended, the mixture was cooled to 120° C. and catalyzed with 180 mg of tin dichloride. The reaction mixture was heated slowly to 200° C. over 4 hrs. under a water jet vacuum, with additional water being eliminated. The mixture was left to stand for a further 24 hrs. under these reaction conditions and the hydroxyl number of polyester polyol A.5. was then determined to be 60.1 mg KOH/g and the acid number was 0.7 mg KOH/g. Polyester polyol A.5. had a viscosity of 8930 mPas (at 25° C.).

B.) OH-Terminated Prepolymers and Modified Polyester Polyols

B.1. OH-Terminated Prepolymer (According to the Invention)

This OH-terminated prepolymer was prepared by reacting, at 100° C. for 3 hrs., 1260 g of polytetrahydrofuran having a number-average molecular weight of 650 g (poly-THF 650, BASF AG) with 244 g of a polyisocyanate of the diphenylmethane series until the NCO content reached 0%. The OH number of OH-terminated prepolymer B.1. was 91.1 mg KOH/g; the viscosity was determined as 73,900 mPas at 25° C. and 15,100 mPas at 50° C.

B.2. OH-Terminated Prepolymer (Comparative)

This OH-terminated prepolymer was prepared by reacting, 463 g of polyadipatepolyol A.3. with 62.5 g of a polyisocyanate of the diphenylmethane series until the NCO content reached 0%. These were first reacted for one hour at 80° C., then for one hour at 100° C., and then for a further two hours at 110° C. The viscosity of the OH-terminated prepolymer B.2.was as 2,950 mPas (at 75° C.).

B.3. Polyether Polyol Containing Acrylate End Groups (Comparative)

A polyether polyol was prepared by slowly adding, at 50° C., 144 g of methyl acrylate to 4,000 g of polypropylene oxide with an OH number of 28 mg KOH/g, based on TMP as the starter molecule, and 1 g of titanium tetraisobutylate, with methanol being removed from the reaction mixture at elevated temperature. The OH number of polyether polyol B.3.containing acrylate end groups was 21 mg KOH/g and the viscosity was 1,700 mPas at 25° C.

B.4. Polyester Polyol Containing Maleic Acid (Comparative)

A polyester polyol was prepared by reacting ,at 200° C., 1148 g (7.65 mol) of triethylene glycol, 583 g (5.95 mol) of maleic anhydride and 0.5 g of hydroquinone, ultimately under vacuum, in a melt polycondensation process under tin dichloride catalysis (40 mg), with water being eliminated. The OH number of polyester polyol B.4. was 112 mg KOH/g; the acid number was determined as 0.9 mg KOH/g.

B.5. Polyester Polyol Containing Maleic Acid (Comparative)

Polyester polyol B.5. was prepared by reacting, at 200° C., 5548 g (38 mol) of adipic acid, 196 g (2 mol) of maleic anhydride, 1728 g (27.87 mol) of ethylene glycol and 1728 g (16.3 mol) of diethylene glycol, ultimately under vacuum, in a melt polycondensation process under tin dichloride catalysis (200 mg), with water being eliminated. The OH number of polyester polyol B.5. was 55 mg KOH/g; the acid number was determined as 0.2 mg KOH/g. Polyester polyol B.5. had a viscosity at 25° C. of 2,550 mPas.

C.) Polymer Dispersions

C. 1. Preparation of a Polymer Dispersion (According to the Invention)

Polymer dispersion C. 1. was prepared by stirring 476 g of polyetherester polyol A.1. with 3 g of OH-terminated prepolymer B.1., 100 g of toluene and 1 g of azobis(2-methylbutyronitrile). A gentle stream of nitrogen was passed through the solution for 20 min, 80 g of styrene were added and the mixture was heated to 80° C. over 30 min, with stirring. After 20 min at 80° C., the temperature was raised to 115° C. over a further 30 min.

A previously prepared solution of 600 g of polyetherester polyol A.1., 21 g of OH-terminated prepolymer B.1., 200 g of toluene, 5.4 g of azobis(2-methylbutyronitrile) and 430 g of styrene was metered into the above mixture over 2 hrs. at an initial speed of rotation of 300 rpm, the speed being increased to 350 rpm after 20 min., and to 400 rpm after a further 40 min. When this metered addition had ended, the reaction was allowed to continue for 5 min.

Another previously prepared solution of 38 g of polyetherester polyol A. 1., 2 g of OH-terminated prepolymer B.1., 50 g of toluene and 0.6 g of azobis(2-methylbutyronitrile) was then metered in over 30 min. When the addition had ended, the reaction was allowed to continue for 2 hrs. at 120° C.

To work-up the reaction mixture, it was first placed under a water jet vacuum to extensively to remove the solvent and any unreacted styrene. This was completed by applying an oil pump vacuum, both styrene and toluene having been very extensively removed after 2 hours at 0.5 mbar.

The resultant polymer dispersion obtained could be filtered on a 100 μm sieve, was phase-stable and had a viscosity of 18,500 mPas at 25° C. and of 4,350 mPas at 50° C. The filler content (i.e. solids content) was approx. 25.5 wt. % and the OH number was 61.4 mg KOH/g.

C.2. Preparation of A Polymer Dispersion Using an OH-Terminated Prepolymer Based on Polyadipate (Comparative)

| | |
|---|---|
| Initial ingredients: | 476 g of polyester polyol A.2. |
| | 3.0 g of OH-terminated prepolymer B.2. |
| | 100 g of toluene |
| | 80 g of styrene |
| | 1 g of azobis(2-methylbutyronitrile) |

These were heated to 115° C. and the following mixtures were metered in analogously to Example C. 1.:

| | |
|---|---|
| Addition 1: | 600 g of polyester polyol A.2. |
| | 21 g of OH-terminated prepolymer B.2. |
| | 200 g of toluene |
| | 800 g of styrene |
| | 6.4 g of azobis(2-methylbutyronitrile) |
| Addition 2: | 38 g of polyester polyol A.2. |
| | 4 g of OH-terminated prepolymer B.2. |
| | 100 g of toluene |
| | 0.6 g of azobis(2-methylbutyronitrile) |

The OH number of the resultant polymer dispersion was determined as 18 mg KOH/g prior to filtration. The batch was mixed with 1,123 g of polyester polyol A.3.

The resulting dispersion could not easily be filtered on a 200 μm sieve. An appreciable filter residue remained, so the filtration behavior could be graded as unsatisfactory. However, the dispersion was phase-stable and had a viscosity of 26,800 mPas at 25° C. and of 5,340 mPas at 50° C.; the filler content (i.e. solids content) was approx. 23.9 wt. % and the OH number was 57.7 mg KOH/g.

C.3. Preparation of A Polymer Dispersion Using A Polyether Polyol Containing Acrylate Groups (Comparative)

| | |
|---|---|
| Initial ingredients: | 476 g of polyester polyol A.4. |
| | 8.7 g of modified polyether polyol B.3. |
| | 200 g of toluene |
| | 80 g of styrene |
| | 0.6 g of azobis(2-methylbutyronitrile) |

These were heated to 115° C. and the following mixtures were metered in analogously to Example C. 1.:

| | |
|---|---|
| Addition 1: | 538 g of polyester polyol A.4. |
| | 43 g of modified polyether polyol B.3. |
| | 200 g of toluene |
| | 738 g of styrene |
| | 5.4 g of azobis(2-methylbutyronitrile) |
| Addition 2: | 100 g of polyester polyol A.4. |
| | 10.4 g of modified polyether polyol B.3. |
| | 50 g of toluene |

The dispersion obtained was unstable, with two phases being formed. The filler content was approx. 40 wt. %.

C.4. Preparation of A Polymer Dispersion Using A Polyester Polyol Containing Maleic Acid Units (Comparatives

| | |
|---|---|
| Initial ingredients: | 476 g of polyester polyol A.3. |
| | 8.7 of modified polyester polyol B.4. |
| | 200 g of toluene |
| | 80 g of styrene |
| | 0.6 g of azobis(2-methylbutyronitrile) |
| | 33 g of isopropanol |

These were heated to 115° C. and the following mixtures were metered in analogously to Example C.1.:

| | |
|---|---|
| Addition 1: | 600 g of polyester polyol A.3. |
| | 43 g of modified polyester polyol B.4. |
| | 200 g of toluene |
| | 533 g of styrene |
| | 5.4 g of azobis(2-methylbutyronitrile) |
| Addition 2: | 38 g of polyester polyol A.3. |
| | 10.4 g of modified polyester polyol B.4. |
| | 50 g of toluene |
| | 0.6 g of azobis(2-methylbutyronitrile) |

The dispersion obtained could not be filtered.

C.5. Preparation of A Polymer Dispersion Using A Polyadipate Containing Maleic Acid Units (Comparative)

| | |
|---|---|
| Initial ingredients: | 830 g of polyester polyol A.5. |
| | 50 g of toluene |

These were heated to 120° C. and the following mixture was metered in analogously to Example C.1.:

| | |
|---|---|
| Addition: | 353 g of polyester polyol A.5. |
| | 62 g of modified polyester polyol B.5. |
| | 200 g of toluene |
| | 523 g of styrene |
| | 13 g of azobis(2-methylbutyronitrile) |

The reaction product could not be filtered.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A polymer dispersion comprising the free-radical polymerization product of
(a) at least one olefinically unsaturated monomer, in the presence of
(b) at least one polyester polyol without olefinically unsaturated groups, and
(c) at least one OH-terminated prepolymer comprising the reaction product of
(1) tetrahydrofuran oligomers, with
(2) a substoichiometric proportion of a polyisocyanate component,

2. A process for the preparation of polymer dispersions by
(1) free-radically polymerizing
(a) one or more olefinically unsaturated monomer in the presence of
(b) at least one polyester polyol without olefinically unsaturated groups, and
(c) at least one OH-terminated prepolymer prepared by reacting
(1) tetrahyrofurn oligomers, with
(2) a substoichiometric proportion of a polyisocyanate component.

3. The process of claim 2, wherein (c) the OH-terminated prepolymers are prepared by reacting (1) tetrahydrofuran oligomers, with (2) a substoichiometric proportion of an aromatic polyisocyanate.

4. The process of claim 3, wherein said aromatic polyisocyanate comprises a polyisocyanate of the diphenylmethane series which contains less than 50 wt. % of dinuclear isomers (monomeric diphenylmethane diisocyanate).

5. The process of claim 2, wherein (a) the olefinically unsaturated monomer is selected from the group consisting of styrene, alpha-methylstyrene, ethylstyrene, vinyltoluene, divinylbenzene, isopropylstyrene, chlorostyrene, butadiene, isoprene, pentadiene, acrylic acid, methacrylic acid, methyl methacrylate, vinyl acetate, acrylonitrile, methyl vinyl ketone and mixtures thereof.

6. The process of claim 2 wherein (b) said polyester polyol comprises one or more polycarbonate polyols.

7. A polymer dispersion comprising at least one OH-terminated prepolymer which comprises the reaction product of (1) tetrahydrofuran oligomers, with (2) a substoichiometric proportion of a polyisocyanate component.

8. In a process for the preparation of polyurethanes, comprising reacting one or more polyisocyanate with one or more isocyanate-reactive components, the improvement wherein the isocyanate-reactive components comprise the polymer dispersion of claim 7.

9. A shoe sole comprising the reaction product of one or more polyisocyanates with an isocyanate-reactive component comprising the polymer dispersion of claim 7.
